(19) United States
(12) Patent Application Publication
(10) Pub. No.: US 2016/0006067 A1
(43) Pub. Date: Jan. 7, 2016

(54) ASSEMBLY FOR MAKING A FUEL CELL COMPONENT AND A METHOD OF USING THE ASSEMBLY

(71) Applicant: BALLARD POWER SYSTEMS INC., Burnaby, British Columbia (CA)

(72) Inventor: Manish Khandelwal, South Windsor, CT (US)

(21) Appl. No.: 14/767,850

(22) PCT Filed: Feb. 19, 2013
(86) PCT No.: PCT/US2013/026671

§ 371 Date: Aug. 13, 2015

(51) Int. Cl. H01M 8/08

(52) U.S. Cl. CPC H01M 8/086; H01M 2300/0008

(57) ABSTRACT

According to an example embodiment, a fuel cell component manufacturing assembly includes a support member that is configured to be situated adjacent the fuel cell component to provide support for the component. The support member has a perimeter corresponding to a perimeter of the component. A platen member has a configuration corresponding to at least a portion of the support member for being received against a portion of the component. A temperature of the platen member is controllable to achieve a desired temperature of a material situated adjacent the platen member. The platen member has a surface area that is less than a surface area of the component such that only the portion of the component is subject to pressure resulting from a force urging the platen member and the support member together with the component between the support member and the platen member.

### BACKGROUND

Fuel cells are useful for generating electricity based upon an electrochemical reaction. Facilitating the electrochemical reaction involves controlling how and where reactants, such as hydrogen and oxygen, flow within a cell stack assembly. In the case of phosphoric acid fuel cells, additional measures are utilized to control where the phosphoric acid is within the cell stack assembly.

A variety of approaches have been used or proposed to maintain control over the location or movement of fluid, such as preventing reactant gas leak, within a cell stack assembly. While some of those have proven effective, they are not useful in all types of fuel cells and they may have limitations and drawbacks, such as being prohibitively expensive, labor-intensive or unreliable under certain circumstances.

### SUMMARY

According to an example embodiment, a fuel cell component manufacturing assembly includes a support member that is configured to be situated adjacent the fuel cell component to provide support for the component. The support member has a perimeter corresponding to a perimeter of the component. A platen member has a configuration corresponding to at least a portion of the support member for being received against a portion of the component. A temperature of the platen member is controllable to achieve a desired temperature of a material situated adjacent the platen member. The platen member has a surface area that is less than a surface area of the component such that only the portion of the component is subject to pressure resulting from a force urging the platen member and the support member together with the component between the support member and the platen member.

According to an example embodiment, a method of making a fuel cell component includes situating at least one polymer film layer, which comprises a polymer, against a permeable component layer. The polymer film layer and the permeable component layer are situated between a support member and a platen member. The support member has a perimeter corresponding to a perimeter of the component layer. The platen member has a configuration corresponding to a configuration of the polymer film layer. The platen member has a surface area that is less than a surface area of the component layer. The temperature of at least the platen member is increased to thereby melt the polymer. The support member and the platen member are urged toward each other to apply pressure to the portion of the component layer and the polymer received between the support member and the platen. The portion of the component layer is impregnated with the melted polymer to thereby establish a region on the component layer that is resistant to a flow of fluid through the region.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates an example phosphoric acid fuel cell component.

FIG. 2 schematically illustrates an example assembly for manufacturing a fuel cell component such as the example of FIG. 1.

FIG. 3 schematically shows a plurality of layers used for making the example component of FIG. 1 using an assembly such as that shown in FIG. 2.

FIG. 4 schematically shows a portion of an example process for making a fuel cell component such as the example of FIG. 1.

FIG. 5 schematically shows another portion of the example process.

FIG. 6 schematically shows another example assembly for making a fuel cell component.

### DETAILED DESCRIPTION

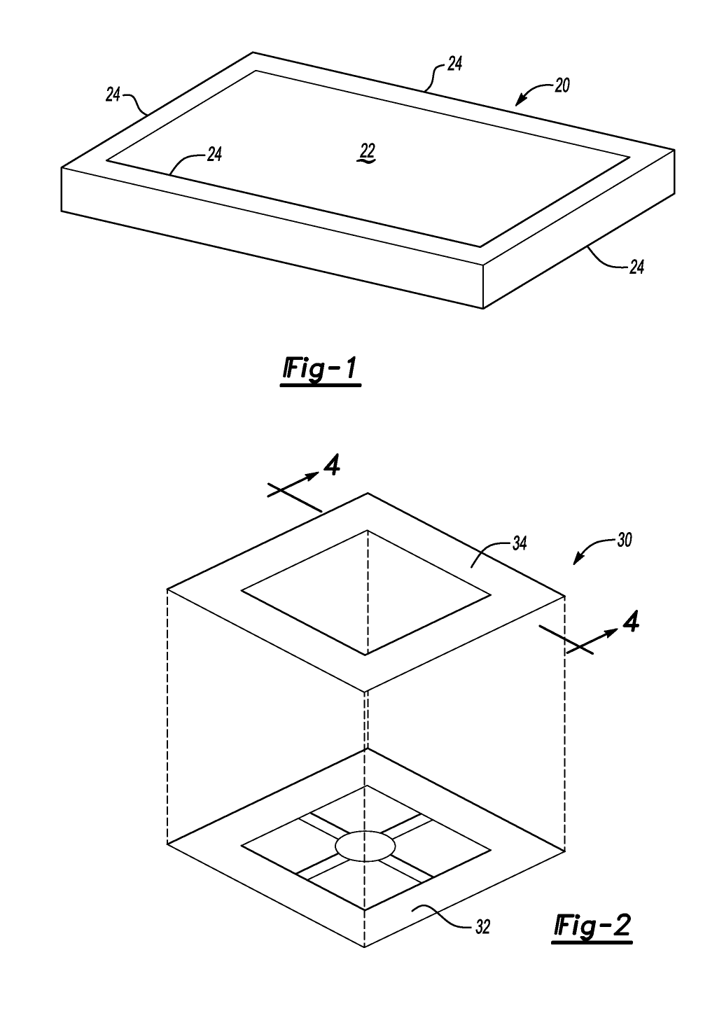

FIG. 1 schematically shows a fuel cell component 20. A permeable component substrate layer 22 includes a region 24 that is impregnated with a polymer. The region 24 establishes a seal along the edges of the component layer 22 in this example. The region 24 is resistant to a flow of fluid, such as phosphoric acid or any reactant gases, through the region 24. The example component 20 may comprise at least one of an electrode, a gas diffusion layer and a catalyst layer.

FIG. 2 schematically shows an assembly 30 that is useful for making a fuel cell component such as the example of FIG. 1. A support member 32 has a configuration, which in this example is rectangular, that corresponds to a configuration of the component 20. The support member 32 provides support for the component during a process that includes using the assembly 30 to establish the region 24. A platen member 34 is selectively situated near the support member 32. In one example, the support member 32 and the platen member 34 are part of a press machine.

The platen member 34 has a configuration that corresponds to a configuration of the region 24 on the fuel cell component 20. In the example of FIG. 2, the platen member 34 has a rectangular, frame-like configuration. The central portion of the platen member 34 is open. With such a configuration, only the portion of the component layer 22 that ends up including the region 24 is subjected to pressure as the platen member 34 and the support member 32 are urged toward each other.

One feature of the example arrangement is that the portion of the component layer 22 that is not subjected to pressure will not be altered or otherwise negatively affected by the process used for establishing the region 24 on the component 20. For example, when the platen member 34 is heated for purposes of melting a polymer (as explained below), the portion of the component layer 22 that would be situated within the central opening of the platen member 34 is not exposed to such pressure and heat. The illustrated arrangement allows for better consistency among components processed using the assembly 30 and reduces any risk of negatively affecting the component layer 22 during the process.

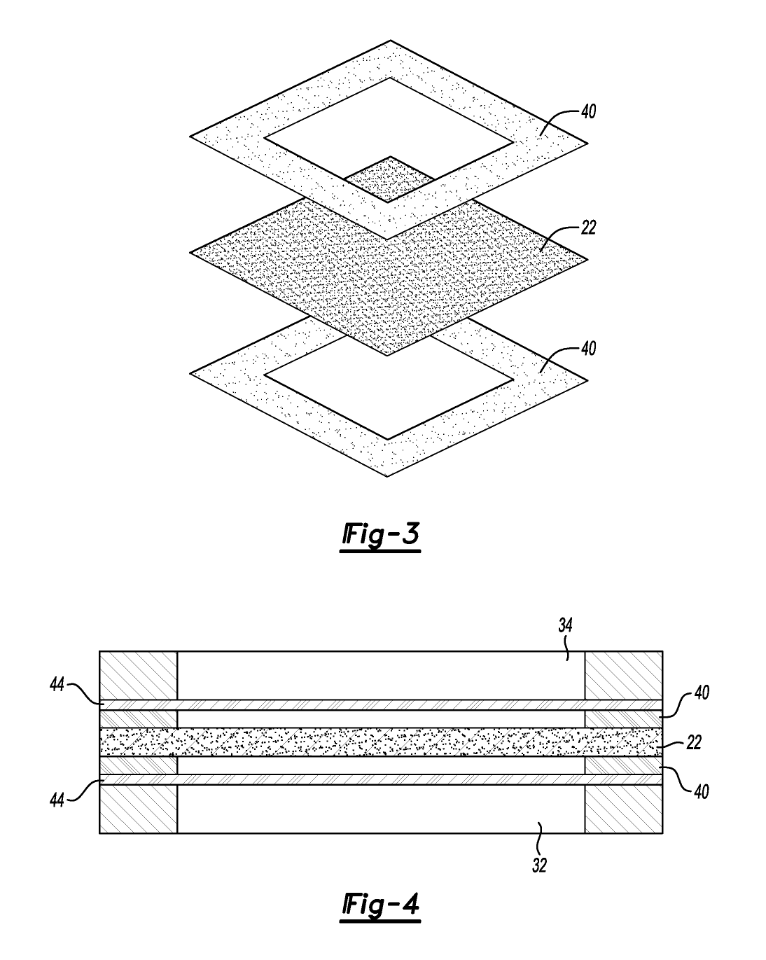

FIG. 3 schematically shows an example arrangement of layers that may be placed between the support member 32 and the platen member 34. The component substrate layer 22 is situated between polymer film layers 40. Example materials that are useful as the polymer film layers 40 include PEEK™ and Teflon™, which are both commercially available. The polymer film layers 40 in one example comprise a high melt flow (e.g., 0.25 g/10 mins per ASTM D2116) polymer that is non-wetting and thermally stable below a temperature of approximately 220° C. The polymer is also chemically resistant to phosphoric acid.

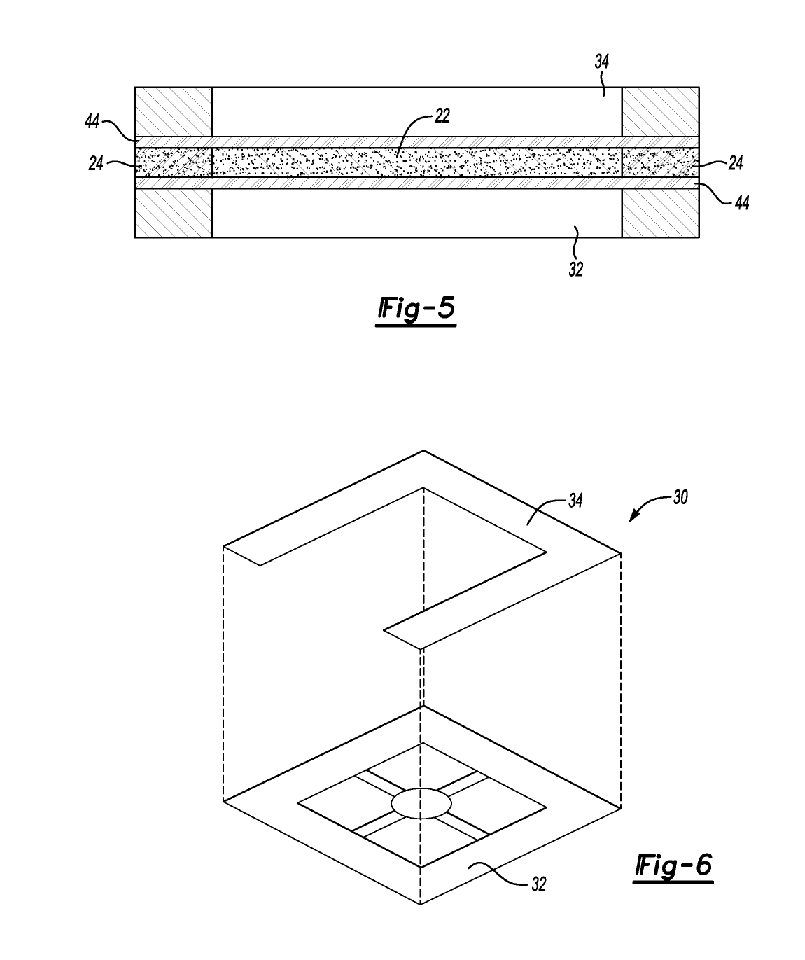

As shown in FIGS. 4 and 5, an example process of using the assembly 30 for making the fuel cell component 20 includes situating the substrate layer 22 with the polymer film layers 40 between the support member 32 and the platen member 34. In this example, release films 44 are included to make it easier to separate the eventual component 20 from the support member 32 and the platen member 34.

The perspective of FIG. 4 corresponds to a cross-sectional illustration generally corresponding to a view along the lines 4-4 in FIG. 2 if the various layers shown in FIG. 4 were all included between the support member 32 and the platen member 34 with those members being drawn together into the position shown in FIG. 4.

In this example, the support member 32 and the platen member 34 are each heated to increase the temperature of the polymer of the film layers 40 to the point of melting the polymer. Pressure used for urging the support member 32 and platen member 34 together compresses the melted polymer into the substrate layer 22 to establish the impregnated region 24. As can be appreciated in FIG. 5, the pressure applied by the support member 32 and the platen member 34 in this example is only exerted on the area of the component layer 22 where the region 24 is established. The electrochemically active portion (also referred to as the active area) of the component layer 22 that does not include impregnation by the polymer is not subjected to any pressure or heat treatment during the example method.

The example of FIG. 2 is useful when an entire perimeter of a component layer 22 will include a seal or phosphoric acid-impermeable region 24. In some situations, it is desirable to provide a polymer impregnated region 24 on less than all of the edges of the components substrate layer 22. FIG. 6 is an illustration of an example arrangement of a platen member 34 that is useful for establishing the region 24 along three edges of the component layer 22. The platen member 34 in the example of FIG. 6 has a generally U-shaped configuration with three edges corresponding to three edges of the component substrate layer 22. The polymer film layer used in an example including the assembly of FIG. 6 also has a three-sided or generally U-shaped configuration corresponding to the configuration of the platen member 34.

The disclosed example assemblies and techniques allow for establishing a seal or fluid barrier along selected portions of a fuel cell component substrate in a cost-effective and efficient manner that reduces risks associated with exposing the substrate material to heat, pressure or both.

The preceding description is illustrative rather than limiting in nature. Variations and modifications to the disclosed examples may become apparent to those skilled in the art that do not necessarily depart from the essence of the contribution to the art provided by the disclosed examples. The scope of legal protection provided to the invention can only be determined by studying the following claims.

I claim:

1. A fuel cell component manufacturing assembly, comprising:
a support member configured to be situated adjacent the fuel cell component to provide support for the component, the support member having a perimeter corresponding to a perimeter of the component; and
a platen member having a configuration corresponding to at least a portion of the support member for being received against a portion of the component, a temperature of the platen member being controllable to achieve a desired temperature of a material situated adjacent the platen member, the platen member having a surface area that is less than a surface area of the component such that only the portion of the component is subjected to pressure resulting from a force urging the platen member and the support member together with the component between the support member and the platen member.

2. The assembly of claim 1, wherein the platen member has a rectangular configuration.

3. The assembly of claim 2, wherein the support member has a rectangular configuration.

4. The assembly of claim 3, wherein the rectangular configurations are the same.

5. The assembly of claim 1, wherein the platen member has a generally U-shaped configuration.

6. The assembly of claim 5, wherein the support member has a rectangular configuration;
the support member has a surface area that is less than the surface area of the component; and
three sides of the platen member are situated to be aligned with three sides of the support member.

7. The assembly of claim 1, wherein the platen member configuration corresponds to at least one edge of the component.

8. The assembly of claim 7, wherein the platen member has a portion corresponding to each edge of the component.

9. The assembly of claim 1, wherein the component comprises at least one of an electrode, a gas diffusion layer and a catalyst layer.

10. The assembly of claim 1, wherein a temperature of the support member is controllable to achieve a desired temperature of a material situated adjacent the support member.

11. A method of making a fuel cell component, comprising the steps of:
situating at least one polymer film layer against a permeable component layer;
situating the at least one polymer film layer and the permeable component layer between a support member and a platen member, wherein the support member has a perimeter corresponding to a perimeter of the component layer, the platen member has a configuration corresponding to a configuration of the polymer film layer, and the platen member has a surface area that is less than a surface area of the component layer;
increasing a temperature of at least the platen member to thereby melt the polymer;
urging the support member and the platen member toward each other to apply pressure to the portion of the component layer and the polymer received between the support member and the platen; and
impregnating the portion of the component layer with the melted polymer to thereby establish a region on the component layer that is resistant to a flow of fluid through the region.

12. The method of claim 11, wherein
the component layer has a rectangular configuration; and
the platen member has a rectangular configuration corresponding to the rectangular configuration of the component layer.

13. The method of claim 11, wherein the support member has a rectangular configuration.

14. The method of claim 11, wherein the polymer film layer and the platen member each has a generally U-shaped configuration.

15. The method of claim 11, wherein the platen member configuration corresponds to at least one edge of the component.

16. The method of claim 15, wherein the polymer film layer and the platen member each has a portion corresponding to each edge of the component.

17. The method of claim 11, wherein the component comprises at least one of an electrode, a gas diffusion layer and a catalyst layer.

18. The method of claim 11, wherein the polymer film layer comprises a high melt flow polymer that is non-wetting and thermally stable below a temperature of approximately 220° C.

19. The method of claim 11, comprising situating a first polymer film layer against one side of the component layer and a second polymer film layer against an oppositely facing side of the component layer.
